(19) United States
(12) Patent Application Publication
(10) Pub. No.: US 2024/0138393 A1
(43) Pub. Date: May 2, 2024

(54) Lighted Insect Trap

(71) Applicant: Alliance Sports Group, L.P., Roanoke, TX (US)

(72) Inventors: Clark McCune, Roanoke, TX (US); Todd Lee Marcucci, Mansfield, TX (US); James Brandon Roach, Keller, TX (US)

(21) Appl. No.: 18/469,411

(22) Filed: Sep. 18, 2023

Related U.S. Application Data
(60) Provisional application No. 63/419,558, filed on Oct. 26, 2022.

(51) Int. Cl. A01M 1/14

(52) U.S. Cl. CPC A01M 1/145

(57) ABSTRACT

A lighted insect trap having a main body that is coupleable to a power source. A cover is couplable to the main body, either removably, moveably, or fixedly. A plurality of opposing arms extend upward from the main body, the opposing arms being configured to receive a card between the opposing arms. A card having an adhesive layer is disposed between the opposing arms. A light source is disposed about the main body and is configured to propagate light about the plurality of arms.

### PRIORITY CLAIM

The present application claims priority to U.S. Ser. No. 63/419,558 filed on Oct. 26, 2022 entitled “Lighted Insect Trap” which is incorporated herein by reference in its entirety.

### FIELD OF THE INVENTION

The present invention relates generally to insect trap devices, systems, and associated methods and more particularly to an improved apparatus and system for trapping insects for disposal.

### BACKGROUND

Insect traps are commonly used in an effort to eliminate the nuisance and potential health problems associated with disease vectors and overall undesirable nature of insects in and around living spaces. Insects may be attracted to different types of light. Conventional lighting devices used to attract insects have complicated heating elements or other hazards associated therewith that make them undesirable for use in an environment that may be accessible to vulnerable persons. Aspects of the current technology eliminate heating elements and improve lighting propagation and trap disposal. Other advantages are apparent in the description of aspects of the technology.

### BRIEF DESCRIPTION OF THE DRAWINGS

To further clarify the above and other aspects of the present technology, a more particular description of the invention will be rendered by reference to specific aspects thereof which are illustrated in the appended drawings. It is appreciated that these drawings depict only typical aspects of the technology and are therefore not to be considered limiting of its scope. The drawings are not drawn to scale. The technology will be described and explained with additional specificity and detail through the use of the accompanying drawings in which:

FIG. 1 is a perspective view of a lighted insect device in accordance with one aspect of the technology;

FIG. 2 is a side view of a lighted insect device in accordance with one aspect of the technology;

FIG. 3 is another side view of a lighted insect device in accordance with one aspect of the technology;

FIG. 4 is a front view of a lighted insect device in accordance with one aspect of the technology;

FIG. 5 is a back view of a lighted insect device in accordance with one aspect of the technology;

FIG. 6 is a top view of a lighted insect device in accordance with one aspect of the technology;

FIG. 7 is a bottom view of a lighted insect device in accordance with one aspect of the technology;

FIG. 8 is a perspective view of a lighted insect device in accordance with one aspect of the technology;

FIG. 9A is a view of a lighted insect device in accordance with one aspect of the technology;

FIG. 9B is a view of a lighted insect device in accordance with one aspect of the technology;

FIG. 9C is a view of a lighted insect device in accordance with one aspect of the technology; and

FIG. 9D is a view of a lighted insect device in accordance with one aspect of the technology.

### DESCRIPTION OF ASPECTS OF TECHNOLOGY

Although the following detailed description contains many specifics for the purpose of illustration, a person of ordinary skill in the art will appreciate that many variations and alterations to the following details can be made and are considered to be included herein. Accordingly, the following embodiments are set forth without any loss of generality to, and without imposing limitations upon, any claims set forth. It is also to be understood that the terminology used herein is for the purpose of describing particular embodiments only, and is not intended to be limiting. Unless defined otherwise, all technical and scientific terms used herein have the same meaning as commonly understood by one of ordinary skill in the art to which this disclosure belongs.

As used in this specification and the appended claims, the singular forms “a,” “an” and “the” include plural referents unless the context clearly dictates otherwise. Thus, for example, reference to “a layer” includes a plurality of such layers.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that any terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein. The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. Unless otherwise stated, use of the term “about” in accordance with a specific number or numerical range should also be understood to provide support for such numerical terms or range without the term “about”. For example, for the sake of convenience and brevity, a numerical range of “about 50 angstroms to about 80 angstroms” should also be understood to provide support for the range of “50 angstroms to 80 angstroms.”

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

Reference in this specification may be made to devices, structures, systems, or methods that provide “improved” performance. It is to be understood that unless otherwise stated, such “improvement” is a measure of a benefit obtained based on a comparison to devices, structures, systems or methods in the prior art. Furthermore, it is to be understood that the degree of improved performance may vary between disclosed embodiments and that no equality or consistency in the amount, degree, or realization of improved performance is to be assumed as universally applicable.

### Example Embodiments

An initial overview of technology embodiments is provided below and specific technology embodiments are then described in further detail. This initial summary is intended to aid readers in understanding the technology more quickly, but is not intended to identify key or essential features of the technology, nor is it intended to limit the scope of the claimed subject matter.

Broadly speaking, aspects of the disclosed technology create an improved lighting apparatus use in connection with a lighted insect trap 10 having a flat transparent adhesive card 40 removably disposed in a main body 20. The main body 20 comprises a light source 30 coupled to a plurality of arms 21 disposed about opposing sides of the main body 20. The adhesive card 40 is slidable in and out of the plurality of arms 21. In one aspect, the arms 21 of the main body 20 are configured to conduct light from the light source 30 up from the main body and into the adhesive card 40. In this manner, light is distributed evenly about the adhesive card 40 so as to optimize insect attractiveness to the adhesive card 40 without propagating excessive unwanted light outside of the trap 10 and minimizing the number of LEDs and the LED footprint within the main body 20. For example, in one aspect of the technology an LED is disposed about a top portion of the main body 20. A window or open space is disposed about the top of the main body and light from an LED is propagated therethrough to the card 40. In addition, the trap 10 is intended to attract and trap insects without the use of a heating element.

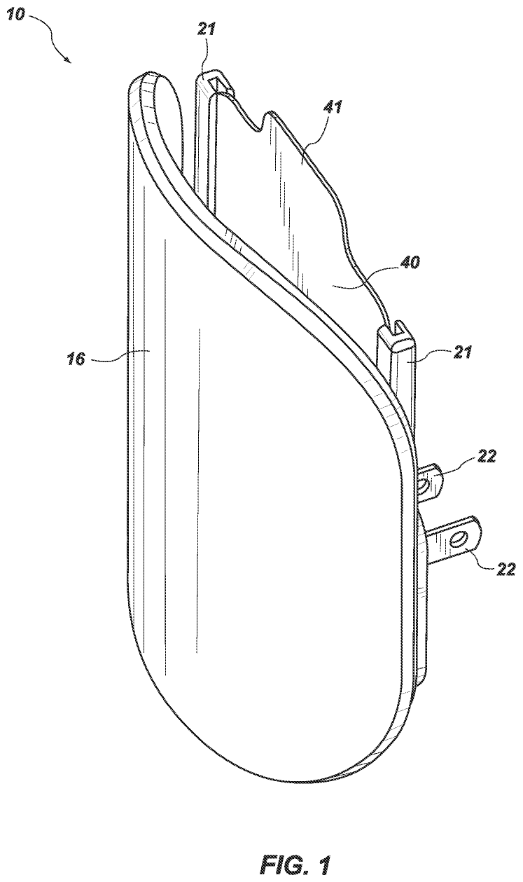

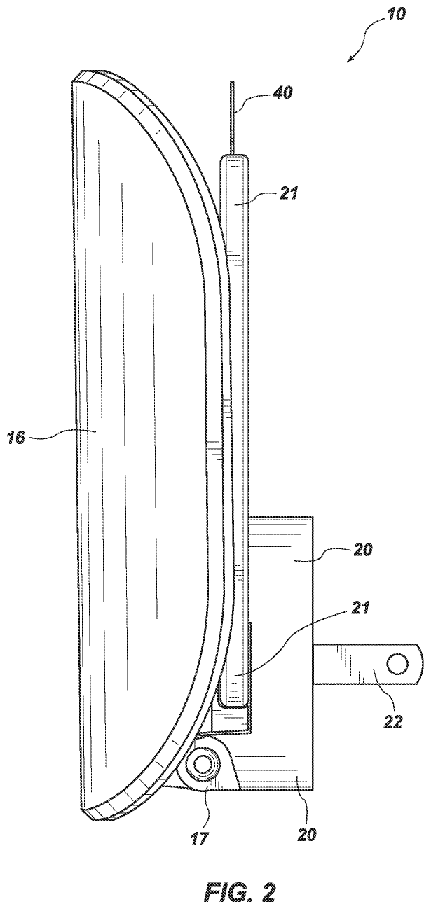

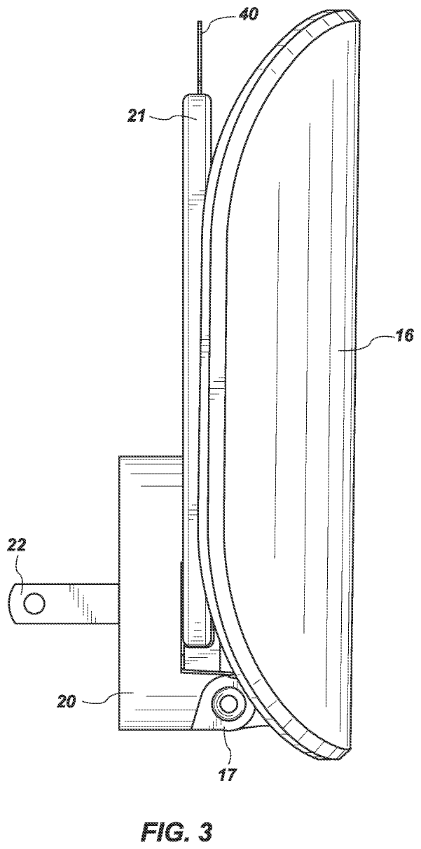

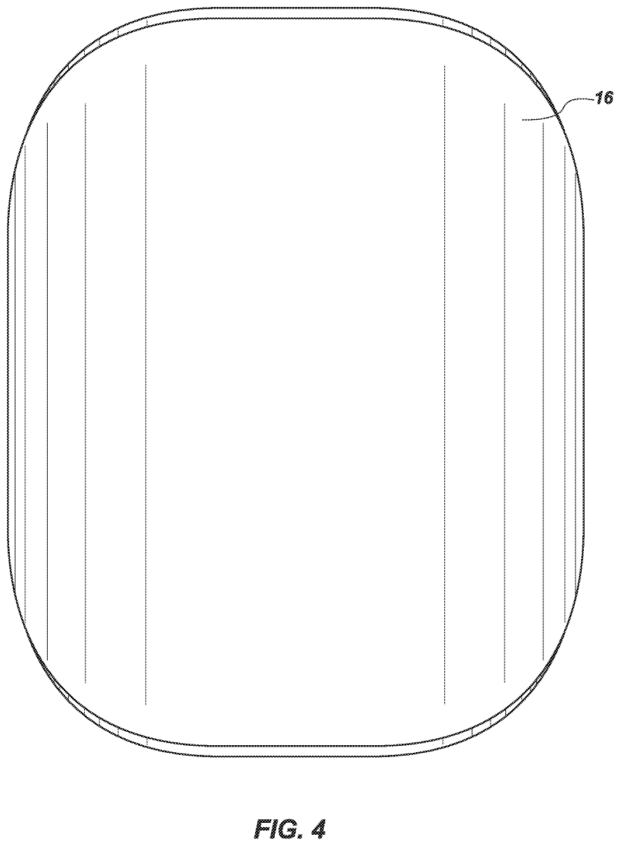

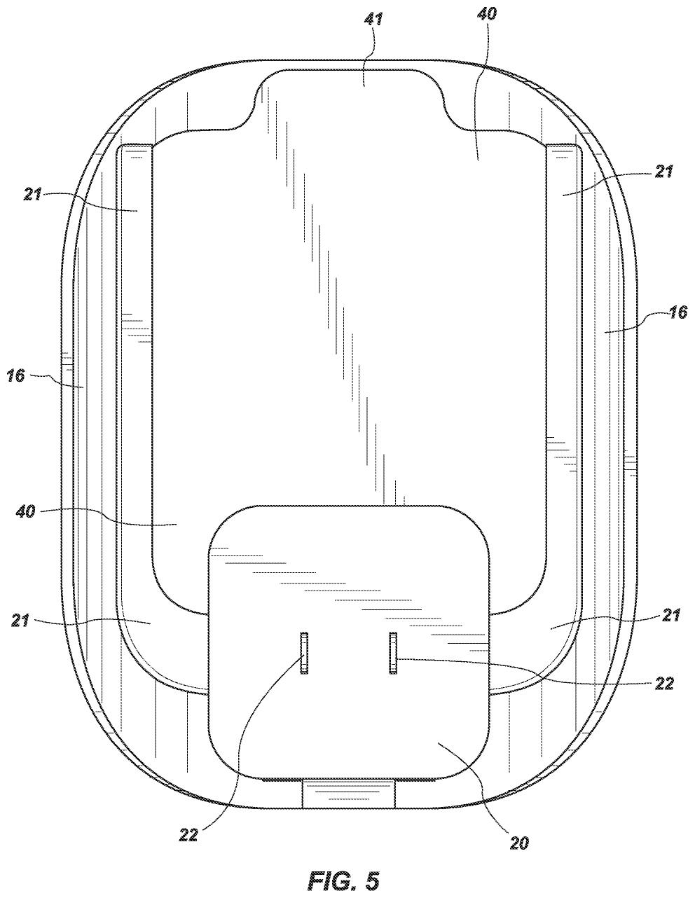

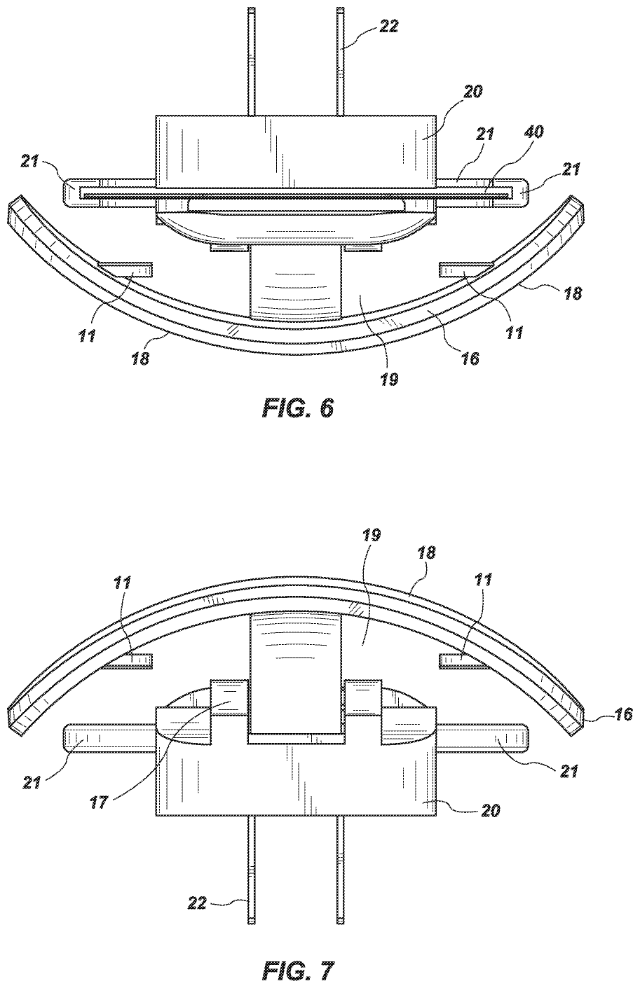

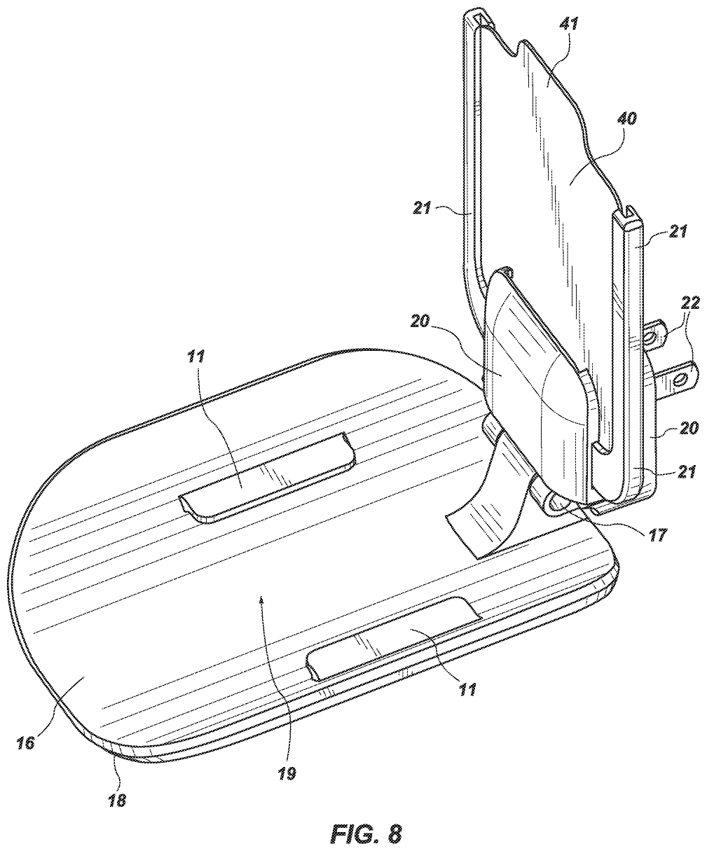

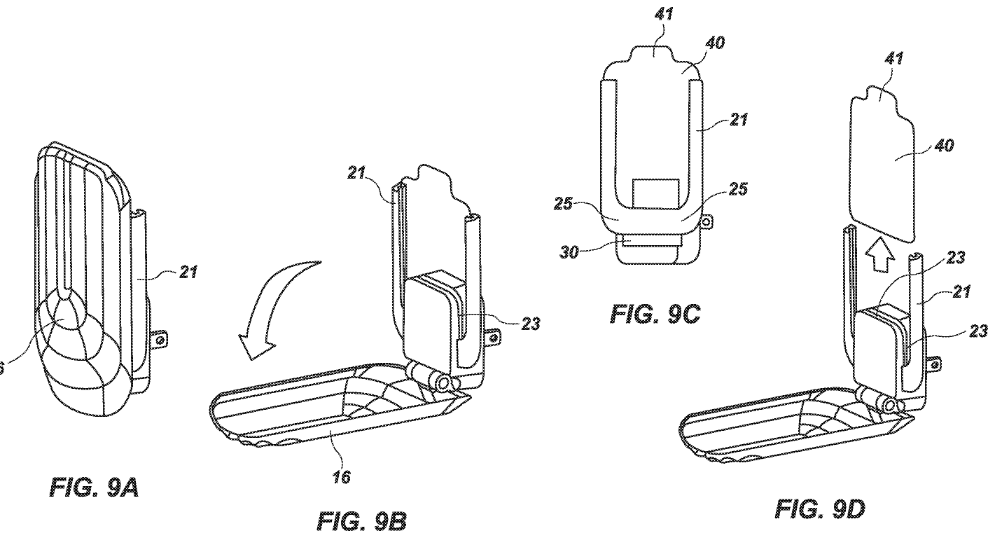

With reference now to the figures, FIGS. 1-2 illustrates one example of a lighted insect trap 10 in accordance with one aspect of the technology. The lighted insect trap 10 generally comprises a cover 16 coupled to a main body 20. The main body 20 comprises a plurality of prongs 22 configured to plug into an electric outlet appropriate to the voltage and outlet standards of the region in which it is used. In another aspect, the main body 20 comprises a compartment for batteries to be disposed to operate the device on battery power. In one aspect where battery power is contemplated, the cover 16 would extend about the entire main body 20 operating as a housing.

In one aspect of the technology, the plurality of arms 21 extend outward about a side of the main body 20 and upward from the main body 20. The plurality of arms 21 define a space between opposing arms for the insertion of the adhesive card 40 therein. In one aspect, the arms are substantially linear and configured to receive a substantially flat and rectangular adhesive card 40 therein. However, it is understood that different shapes of adhesive cards 40 are contemplated for use herein. Moreover, the plurality of arms 21 can be arranged to accept different shapes of adhesive cards 40. For example, in one aspect of the technology, the arms are curvilinear and are configured to receive an oval or circular card 40 therein. In that aspect, the arms 21 pivot near a connection point with the base 20. The arms are biased in a “closed” position, but are moveable in a lateral direction away from the base in order to accommodate placement of a card 40 between the arms 21.

In one aspect, the plurality of arms 21 are disposed about a bottom portion 22 of the main body 20. A portion of the space between the arms 21 correspond to a slot 23 within the main body 20 configured to receive a bottom portion of the adhesive card 40 therein. In another aspect, the arms 21 also have slots 23 therein, to receive side portions of the card 40 therein.

In another aspect of the technology, the plurality of arms 21 are part of a continuous card receptacle 25 disposed about the main body 20. In one aspect, the continuous card receptacle 25 comprises a general U-shape configured to receive outer edges of the adhesive card 40 therein. The continuous card receptacle is disposed within the main body 20, a portion of the bottom of the U corresponding to a slot 23 within the main body 20.

In one aspect of the technology, the plurality of arms 21 or card receptacle 25 function as a light pipe to receive and distribute light from the light source 30 about the adhesive card 40. In one aspect, the plurality of arms 21 (or alternatively the entire card receptacle 25) comprise a translucent material that conducts light from the light source 30 through the entire body of the arms 21 or receptacle 25. In one aspect, an outer portion of the arms 21 or receptacle 25 comprises a light barrier or reflective layer to minimize the amount of light escaping from the arms 21 or receptacle 25. An inner portion of the arms 21 or receptacle 25 (i.e., the portion facing the card 40) does not have the reflecting or light obstructive material thereon. In this manner, the light is directed inward towards the card 40. Advantageously, arms 21 or receptacle 25 more evenly distribute light about the adhesive card 40 which is also translucent, in one aspect. The adhesive card 40 does not need to be translucent in every application, however. In an additional aspect of the technology, the card receptacle 25 or arms 21 are not located within the main body 20. Rather, they are disposed about an outside portion of the main body such that the card 40 is disposed on either a front or back side of the main body 20.

In one aspect of the technology, the cover 16 is attached by way of a hinge 17 to the main body 20 so it may pivot away from the main body 20. This facilitates replacement of the adhesive card 40. In another aspect, the cover 16 may be rotated from about 90 degrees to 180 degrees in a clockwise or counterclockwise direction in a plane that is parallel with the card 40 to expose the adhesive card 40 for ease of replacement. In another aspect of the technology, the cover 16 is removable from the main body 20 so that alternative covers that match the desired décor of the user may be coupled thereto. For example, in one aspect of the technology, the lighted insect trap is sold as a kit with a plurality of alternative covers. In accordance with one aspect of the technology, the cover 16 has a curved outer surface 18 creating a void 19 on an inner surface. The void 19 is configured to fit replacement adhesive cards 40 therein retained by a pair of tabs 11. The replacement adhesive cards 40 are not intended to be activated or actively catch pests thereon while they are stored in the void 19. Rather, when a card 40 that is inserted within the plurality of arms 21 is no longer viable and needs to be replaced, a user may remove the existing card 40 and replace it with one stored in the void 19 of cover 16. In one aspect of the technology, the lighted insect trap 10 is sold as a kit with a plurality of adhesive cards 40 within one or more covers.

In one aspect of the technology, the adhesive card 40 comprises a translucent or transparent material having one or both primary sides of the card coated or treated with an adhesive. In one aspect the card comprises a flexible polymeric material such as PET (polyethylene terephthalate), PC (polycarbonate), PS (polystyrene), acrylic, or some other thin plastic. It may be transparent or translucent as suits a particular application. The card 40 comprises a tab 41 that is not treated or coated with an adhesive so the user may readily touch the card for removal and insertion into the plurality of arms 21 and/or the slot 23 in the arms. Likewise, the side and bottom edges of the card 40 that are in contact with the arms 21 are not coated with the adhesive. In one aspect, the adhesive comprises a natural adhesive comprising animal or vegetable oils, a thermoplastic polymer adhesive, or elastomeric adhesive. The card 40 is covered with a removable film about the exterior of the adhesive on one or both sides of the card. The film is peeled away by the user before insertion into the arms 21 so that insects attracted to the light are adhered thereon.

In one aspect of the technology, the arms 21 extend upward from the main body to a height sufficient to retain all or nearly all of the height of the sides of the card 40 therein. In another aspect, however, the arms 21 extend upward to a height that retains less than all of the height of the sides of the card 40. For example, in one aspect, the arms 21 extend upward to encompass or retain about half the height of the card 40. These aspects balance the amount of material used in manufacturing with the amount of light propagated on the card 40 and the retention of the card 40 within the trap.

In another aspect of the technology, the card receptacle 25 comprises a slot 23 in the main body 20 without the arms 21. In this aspect, the depth of the slot 23 functions to stabilize the card 40 in slot 23 and retain the card 40 sufficient to function as an insect trap. Light is propagated to the card 40 via a light source 30 disposed about the main body 20.

In still another aspect, the card 40 extends in more than a single plane. Meaning, the card 40 itself resides in multiple intersecting planes and/or is curvilinear. For example, in one aspect, the card 40 comprises a general U-shape. The slot 23 in main body 21 is likewise generally U-shaped. In this manner, the card 40 has greater vertical stability with a shallow slot 23.

In one aspect of the technology, a color-changing compound is disposed about the card 40 which changes color after a predetermined period of time based on environmental conditions (e.g., heat, humidity, age, etc.). The change in color indicates to the consumer that the card 40 is not optimally adhering insects and should be changed. In one aspect of the technology, the color-changing compound detects the presence of CO2 or exposure to atmosphere, or works by migration of a dye and is disposed about a portion of the card 40 that is beneath the film so that the compound is exposed to the environment at the same time as the underlying adhesive. For example, in one aspect, a colored dye disposed under the adhesive protector, or applied at the time of first use, bleeds into the adhesive slowly based on molecular weight and viscosity at a rate that coincides with the expected life of the adhesive. The color of the dye and adhesive are designed to allow a clear indication to the user of an indicator that fades with time or changes color to indicate the relative age or expiration of the adhesive. In one aspect, the dye changes from a green color to a red color indicating that the adhesive is ready to be changed. In another example, the color changing compound comprises an acid-base reaction between chemicals including, but not limited to, bromophenol blue sodium (BPB-Na) and citric acid (CA). In aqueous solutions at room temperature, alkaline BPB-Na solutions will change from purple to red at pH 4.6 and from red to yellow at pH 3. An indicator layer is made from a permeable hydrogel with dissolved BPB-Na, and similarly an activator layer is made of a hydrogel dissolved with CA. The BPB-Na and CA will diffuse through the hydrogel matrix and begin to react. The rate of this reaction is controlled by altering the initial concentrations of BPB-Na and CA and is formulated to match the expiration of the adhesive. In another aspect, pH dye-based indicators (bromothymol blue and methyl red) that change color with exposure to carbon dioxide (CO2) levels or ambient humidity are applied to the substrate. Once exposed to atmosphere, ambient CO2 alters the pH and thus changes color. The rate of this reaction would also be formulated to match the expiration of the adhesive.

In one aspect of the technology, a replaceable chemical lure is also disposed about the lighted insect trap 10. The chemical lure may be comprised of one or more extracted pheromones, acetic acid+vinegar, lactic acid, eugenol, and/or fruit scents and is disposed about the cover 16 or main body 20 or on the card 40.

The main body 20 comprises a light source 30. In one aspect of the device, the light source 30 comprises a plurality of light emitting diodes (LEDs) and/or chip-on-board (COB) LEDs which specifically refers to LED chips in the form of a semiconductor chip that is neither encased nor connected but directly mounted onto a substrate, such as a printed circuit board (PCB). As such, a plurality of semiconductor light sources may be configured on the same substrate. While reference is made herein to COB LED lights, aspects of the technology are not limited to that specific aspect. Different LED lights/light sources may suffice so long as the light source 30 operates to illuminate the lighted insect trap 10. In addition, while the term LED is used herein in connection with a light source, it is understood that a single LED may be used as the light source or a plurality of LEDs with similar capabilities may be used. Similar LEDs may be disposed on a similar chip or substrate or they may be disposed on different chips and different substrates and disposed about different locations of the housing as suits a particular design. Meaning, LEDs with similar characteristics may be located about numerous different locations of the device. Moreover, other light sources may be used besides LEDs. It is also understood that LEDs capable of operating at different wavelengths of light or only wavelength blocks or segments may be used. In one aspect, an RGB chip is used as the light source 30. In one aspect, an RGB chip comprises three different LED emitters in one case. Each emitter is connected to a separate lead so they can be controlled independently.

In one aspect, the main body 20 further comprises a power switch and a logic controller such as a programmable logic controller or PLC. However, in another aspect, the trap 10 is operated continuously once plugged into a wall socket and receiving power. In one aspect, a control switch is coupled to the PLC and permits the user to switch between different modes of operation. A PLC is a digital computer used for automation of certain electromechanical processes, such as control of machinery on factory assembly lines, amusement rides, or light fixtures. PLCs are designed for multiple arrangements of digital and analog inputs and outputs, extended temperature ranges, immunity to electrical noise, and resistance to vibration and impact. In one aspect, a PLC is not used in the main body 20. Rather, a mode chip or simple LED driver is used to control operations. In one aspect of the technology, the instructions to control operation of the lighting device operation are stored in battery-backed-up or non-volatile memory. Memory refers to electronic circuitry that allows information, typically computer data, to be stored and retrieved.

As will be appreciated by one skilled in the art, aspects of the present technology may be embodied as a system, method or computer program product used in connection with the lighted insect trap 10. Accordingly, aspects of the present technology may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a random access memory (RAM), a read-only memory (ROM), an erasable programmable read-only memory (EPROM or Flash memory), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present technology may be written in any combination of one or more programming languages, including an object-oriented programming language such as Java, Visual Basic, SQL, C++ or the like and conventional procedural programming languages, such as the “C” programming language or similar programming languages.

In one aspect of the technology, the light sources or LEDs are configured with pulse-width modulation (“PWM”) to regulate the brightness or dimness of specific LED lights disposed about the lighted insect trap 10. PWM is one way of regulating the brightness of a light. Thus, for one phase a user may select a first PWM mode and in a different phase a user may select a second PWM mode such that different LED lights on the same chip (or different chips) have different levels of dimness or brightness. In one aspect, light emission from the LED is controlled by pulses wherein the width of these pulses is modulated to control the amount of light perceived by the end user. When the full direct current voltage runs through an LED, the maximum of light is emitted 100% of the time. That is, the LED emits light 100% of the time when in an “on” mode. With PWM, the voltage supplied to the LED can be “on” 50% of the time and “off” 50% of the time so that the LED gives off its maximum amount of light only 50% of the time. This is referred to as a 50% duty cycle. In this scenario, if the on-off cycle is modulated fast enough, human eyes will perceive only half the amount of light coming from the LED. That is, with such an input on the LED, the amount of light given off appears diminished by 50%. While specific reference is made to a 50% duty cycle, the LED duty cycle of the light source described herein may be greater or lesser than 50% as suits a particular purpose. For example, the LED(s) propagating light at different wavelengths may have a duty cycle that ranges from 25% to 40%, 40% to 50%, 50% to 60%, and/or 60% to 75%. They may also have duty cycles that range from 20% to 25%, 25% to 30%, 30% to 35%, 35% to 40%, 40% to 45%, 45% to 50%, 50% to 55%, 55% to 60%, 60% to 65%. 65% to 70%, 70% to 75%, 75% to 80%, 80% to 85%, 85% to 90%, 90% to 95%, and/or 95% to 100%. The range may of course include more than the ranges provided herein and may include a greater range or a smaller range.

While different aspects of the technology are referenced herein, it is understood that one or more aspects may be combined as suits a particular purpose. In one aspect of the technology, the light source 30 is configured to propagate/emit a wavelength of light at about 360 nm, or ranging from about 340 nm to about 380 nm or about 350 nm to about 370 nm. The light source 30 is also configured to propagate a wavelength of light at about 390 nm, or ranging from about 370 nm to about 410 nm, about 380 nm to about 400 nm, or about 395 nm to about 420 nm. The light source 30 may comprise one or more LEDs configured to propagate the different wavelengths of light. In one aspect of the technology, the power level for a first LED (the LED that is less visible to the human eye) is greater than the power level for a second LED (the LED that is more visible to the human eye). Advantageously, the end user perceives the UV LED light (the one more visible to the human eye) and understands that a UV LED light is being used to attract insects. However, the UV LED that is more perceptible to the human eye is operated at a level that requires less power consumption than the second LED that more specifically targets insects to be attracted to the device. In other words, more light (i.e., electromagnetic radiation) is emitted from the light source that is more detectable and attractive to insects than light that is detectable to the human eye.

In another aspect of the technology, a first light source or first LED is configured to propagate a wavelength of light at about 360 nm, or ranging from about 340 nm to about 380 nm, and a second light source or second LED is configured to propagate a wavelength of light at about 390 nm, or ranging from about 370 nm to about 410 nm. In one aspect of the technology, the second light source or second LED (or LED assembly) is configured to propagate light at a static power level. The first light source is configured to operate at a predetermined differing or random differing static power levels or having a pulsing pattern. It is believed that the insect may better perceive a random static power levels or pulsing patterns as movement as opposed to a static UV LED. As the first light source in this aspect is less visible to the human eye, a random or pulsing light pattern would not be a distraction or irritant to the user.

In another aspect of the technology, the lighting devices comprise a first light source or first LED configured to propagate a wavelength of light at about 360 nm, or ranging from about 340 nm to about 380 nm, and a second light source or second LED is configured to propagate a wavelength of light at about 390 nm, or ranging from about 370 nm to about 410 nm. In one aspect of the technology, the second light source or second LED (or LED assembly) is configured to propagate light at a static power level. The first light source is configured to operate having a randomized duty cycle or a preset plurality of duty cycles. Meaning, the first light source operates at a first duty cycle (e.g., 25%) for a first period of time (e.g., 5 s, 10 s, or 15 s) and then operates at a second duty cycle (e.g., 50% or more) for a second period of time (e.g., 5 s, 10 s, or 15 s). In addition, the first and second LEDs may be operated at different duty cycles in order to increase a desired effect by the user. For example, the duty cycle for the first LED could be increased while the duty cycle of the second LED is decreased. In another aspect, the duty cycle of each is substantially the same, but the number of LEDs disposed about the device is different creating a different effect for the end user and/or changing the overall power consumption of the device. That is, a first light source (e.g., the source less visible to the human eye) comprises a plurality of LEDs that are greater than the plurality of LEDs of the second light source or vice versa. The duty cycles for each light source may be the same, but the relative power consumption is different because the total number of LEDs in the light source is different.

In another aspect of the technology, the lighting devices comprise LEDs wherein a frequency of light is propagated from the LEDs for a first period of time (e.g., 5 s, 10 s, or 15 s), a second frequency of light is propagated from the LEDs for a second period of time, and a third frequency of light is propagated from the LEDs for a third period of time. The first, second, and third periods of time may be the same, or they may be different as suits a particular purpose. In an additional aspect, the different frequencies are propagated from different LEDs and not necessarily from the same LED or the same group of LEDs. For example, in one aspect, light is propagated from the lighting device from one or more LEDs at 380 nm for 5 seconds, at 390 nm for 5 seconds, and then 400 nm for 5 seconds. The light may be propagated at a static power level or a variable duty cycle.

In another aspect of the technology, the first LED or first light source comprises one or more LEDs configured to propagate light at a wavelength at about 1000 nm, ranging from about 900 nm to about 1100 nm, corresponding to the normal wavelength at which humans irradiate heat. In one aspect of the technology, the second light source (operating at a UV wavelength and/or visible light wavelength, e.g.,) is maintained at a static power level or a low duty cycle (e.g., 25% to 35%) while the first light source is maintained at a high static power level, a medium or high duty cycle (e.g., 45% to 55% or 65% to 75%, respectively), a randomized static power level, and/or randomized duty cycle, or a preset variation of static power levels or duty cycles as suits a particular purpose. It is believed that certain insects are attracted to the heat signature of the human body. In another aspect of the technology, the third light source comprises a green light operating at wavelengths from about 490 nm to 580 nm. It is believed that certain insects are attracted to these wavelengths as well.

It is understood that this aspect, as well as other aspects described herein, can be used in combination with other aspects. For example, in the aspect immediately describe above (i.e., the human heat signature aspect), a third light source can be incorporated that propagates light in the UV wavelength which may be less visible or not visible at all to the human eye. Moreover, in one aspect, there may be no light source that is visible to the human eye at all. Rather, the device propagates light only in wavelengths that are not visible to the normal human eye. Moreover, while first and second, or first, second, and third LEDs are referenced herein, it is important to note that a single LED may be used that is programmed to emit/propagate different wavelengths of light at different times eliminating the need for multiple LEDs.

It is noted that no specific order is required in these methods unless required by the claims set forth herein, though generally in some embodiments, the method steps can be carried out sequentially. In accordance with one aspect of the technology, in accordance with one aspect of the technology, a method of lighting an insect trap is disclosed comprising the steps of propagating light through a light distribution device that also functions as a receptacle for an adhesive card 40. In one aspect, the light distribution device comprises a receptacle 25 and/or arms 21. The receptacle 25 and/or arms 21 are shaped to receive the adhesive card 40 therein. The method further comprises removing the adhesive card 40 from the insect trap and replacing it with a new adhesive card 40; the adhesive card 40 being translucent. In one aspect, the light source 30 is configured to propagate light at a wavelength ranging from 395 nm to 420 nm, 390 nm to 420 nm, and 380 nm to 420 nm.

In still another aspect, the pair of opposing arms 21 each comprise a front side, back side, an inner side, and an outer side. The inner side of the pair of opposing arms 21 comprises a slot for receiving a portion of the card therein and the front side, back side, and outer side comprise an opaque layer. The pair of opposing arms 21 themselves comprise a translucent material such that when the light is propagated about the opposing arms 21 light is not transmitted through the opaque layer. Rather, light is propagated through the opposing arms 21 and out of the inner side, thus directing light specifically to the card 40.

The foregoing detailed description describes the technology with reference to specific exemplary aspects. However, it will be appreciated that various modifications and changes can be made without departing from the scope of the present technology as set forth in the appended claims. The detailed description and accompanying drawing are to be regarded as merely illustrative, rather than as restrictive, and all such modifications or changes, if any, are intended to fall within the scope of the present technology as described and set forth herein.

More specifically, while illustrative exemplary aspects of the technology have been described herein, the present technology is not limited to these aspects, but includes any and all aspects having modifications, omissions, combinations (e.g., of aspects across various aspects), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. For example, in the present disclosure, the term “preferably” is non-exclusive where it is intended to mean “preferably, but not limited to.” Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus-function are expressly recited in the description herein. Accordingly, the scope of the invention should be determined solely by the appended claims and their legal equivalents, rather than by the descriptions and examples given above.

1. A lighted insect trap, comprising:
a main body coupleable to a power source;
a cover couplable to the main body;
a card having an adhesive disposed thereon;
a plurality of opposing arms extending upward from the main body, the opposing arms configured to receive the card between the opposing arms;
a light source configured to propagate light about the card and a portion of the plurality of arms.

2. The lighted insect trap of claim 1, further comprising a slot disposed about the main body configured to receive a bottom portion of the card therein.

3. The lighted insect trap of claim 1, wherein the plurality of opposing arms comprises a slot for receiving a side portion of the card therein.

4. The lighted insect trap of claim 1, wherein the cover is removably attached to the main body at a bottom portion of the cover.

5. The lighted insect trap of claim 1, wherein the cover is coupled to the main body by a hinge disposed about a bottom portion of the main body and a bottom portion of the cover.

6. The lighted insect trap of claim 1, wherein the cover is rotatably attached to the main body.

7. The lighted insect trap of claim 1, comprising a plurality of cards, wherein a first card is disposed within the plurality of opposing arms and at least a second card is disposed within a void of the cover.

8. The lighted insect trap of claim 7, further comprising a plurality of retaining tabs disposed about a backside of the cover configured to retain at least one card therein.

9. A lighted insect trap, comprising:
a main body coupleable to a power source;
a cover moveably attached to the main body;
a plurality of opposing arms extending upward from the main body, the opposing arms configured to receive a card between the opposing arms;
at least one card disposed between the opposing arms, the at least one translucent card comprising an adhesive on opposing sides of the card;
a light source configured to propagate light about a portion of the plurality of arms;
wherein the plurality of arms are configured to transmit light from the light source to the card.

10. The lighted insect trap of claim 9, wherein the light source is configured to propagate light at a wavelength ranging from about 395 nm to about 420 nm.

11. The lighted insect trap of claim 9, wherein the cover is curvilinear defining a void within a concave surface and further comprising an additional card disposed within the void.

12. The lighted insect trap of claim 9, wherein the trap does not comprise a heating element.

13. The lighted insect trap of claim 9, wherein each of the opposing arms comprises a front side, a back side, an inner side, and an outer side.

14. The lighted insect trap of claim 12, wherein the inner side of each of the opposing arms comprises a slot configured to receive a side edge of the card therein.

15. The lighted insect trap of claim 13, wherein the plurality of opposing arms converge about a bottom portion of each arm and wherein light source is disposed adjacent the area of convergence of the bottom portion of each arm.

16. A method of trapping insects within a trap, comprising:
providing power to a light source disposed within a trap, the trap comprising a pair of opposing arms having a card disposed therebetween, wherein said card comprises an adhesive disposed on opposing sides of the card;
propagating light about two opposing arms thereby illuminating the arms and the card.

17. The method of claim 16, wherein the light source is configured to propagate light at a wavelength ranging from 395 nm to 420 nm, 390 nm to 420 nm, and 380 nm to 420 nm.

18. The method of claim 16, wherein the pair of opposing arms each comprise a front side, back side, an inner side, and an outer side.

19. The method of claim 18, wherein inner side of the pair of opposing arms comprises a slot for receiving a portion of the card therein and the front side, back side, and outer side comprise an opaque layer.

20. The method of claim 18, wherein the pair of opposing arms comprise a translucent material.
